(19) United States
(12) Patent Application Publication
(10) Pub. No.: US 2009/0026127 A1
(43) Pub. Date: Jan. 29, 2009

(54) FILTER BOWL ASSEMBLY

(76) Inventors: Julian Voss, Kalamazoo, MI (US); Steven Meier, Portage, MI (US)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/180,112

(22) Filed: Jul. 25, 2008

Related U.S. Application Data
(60) Provisional application No. 60/951,973, filed on Jul. 26, 2007.

(51) Int. Cl. B01D 27/08; B01D 35/30

(52) U.S. Cl. 210/440

(57) ABSTRACT

A disposable filter bowl assembly includes i) a filter bowl; ii) a filter located in the filter bowl; and iii) a non-removable retainer ring with tabular portions engaging an annular groove internal to the filter bowl in a manner permanently securing the element in the bowl.

### TECHNICAL FIELD

The present invention relates, in general, to a filter module, and more particularly to a disposable filter bowl having a non-removable filter connected therein.

### BACKGROUND

Many types of filters are known in the prior art. Filters are widely known for removing contaminants and other impurities from fluids. A popular type of filter has a housing that encloses a replaceable ring-shaped filter element. The filter element ensures that impurities are removed from the fluid before it is delivered to system components. Mating portions of the filter housing, or a filter housing and head, form an interior enclosure for the filter element, and the portions may be separated for replacement of a spent filter element. Periodic replacement of the filter element is required so that the filter element will not become so loaded with impurities that flow is restricted. It is known that issues may arise when such filter elements are replaced.

One issue is that filter elements with different sizes and/or filtration capabilities often have identical mounting configurations and can fit on the same filter head. However, use of the wrong filter element can cause poor system performance and allow undesirable amounts of contaminants to pass through the system.

Another issue is that individuals may remove a spent filter element and simply re-attach the housing portions without a fresh element. If an automatic drain valve is used in the filter, fluid can be dumped to drain when an element is not installed in the housing which can have harmful effects on the system.

A still further issue is that upon removing the element, an individual may come into contact with the fluid, which typically is fuel or hydraulic fluid, and any impurities on the filter element, and get dirty hands. The user typically has to reach down into the housing to grasp the element, and may come into contact with residual fuel or oil in the housing and on the element. In addition, any fuel or oil remaining on the element may drip off on the surrounding components when the element is removed, thereby fouling the system components; or worse yet, drip off onto the ground and create environmental issues.

### SUMMARY

At least one embodiment of the invention provides a disposable filter bowl assembly comprising: a filter bowl; a filter positioned in the filter bowl; and a non-removable retainer ring engaging the filter bowl in a manner securing the filter within the filter bowl.

At least one embodiment of the invention provides a method for securing a filter in a disposable filter bowl, the method comprising the steps of: providing a generally cylindrical filter bowl having a generally cylindrical interior chamber; forming a groove in the surface of the interior chamber in a plane perpendicular to the axis of the cylindrical filter bowl; providing a retainer ring having an annular portion and a plurality of engaging tabular portions extending radially outward from the annular portion; inserting the filter into the interior chamber of the filter bowl; and inserting the retainer ring into the interior chamber of the filter bowl wherein annular portion of the retainer ring engages the filter and the plurality of engaging tabular portions of the retainer ring engage the groove in the filter bowl in a manner securing the filter within the filter bowl.

At least one embodiment of the invention provides a disposable filter bowl assembly comprising: a generally cylindrical filter bowl having a generally cylindrical interior chamber; a groove formed in the surface of the interior chamber, the groove formed in a plane perpendicular to the axis of the cylindrical filter bowl; a filter positioned in the interior chamber of the filter bowl; and a retainer ring having an annular filter engaging portion and a plurality of filter bowl engaging portions extending radially outward from the filter engaging portion, the filter bowl engaging portions positioned within the groove of the filter bowl securing the filter within the filter bowl.

### BRIEF DESCRIPTION OF THE DRAWING

Embodiments of this invention will now be described in further detail with reference to the accompanying drawing, in which:

FIG. 1 is a partial exploded perspective view an embodiment of the filter bowl assembly of the present invention;

FIG. 2 is a cross-sectional view of the filter bowl shown in FIG. 1;

FIG. 3A is a plan view of the retainer ring shown in FIG. 1;

FIG. 3B is a cross-sectional view of the retainer shown in FIG. 3A, taken substantially along the plane described by the lines 3B-3B in FIG. 3A;

FIG. 4 is a side view, in partial cross-section, of the filter element for the filter bowl assembly;

FIG. 5 is an enlarged view of the end of the filter element in FIG. 4;

FIG. 6 is an end view of the filter element of FIG. 4; and

FIG. 7 is a partially disassembled cross-sectional view of the filter bowl assembly and a filter head.

### DETAILED DESCRIPTION OF THE DRAWINGS

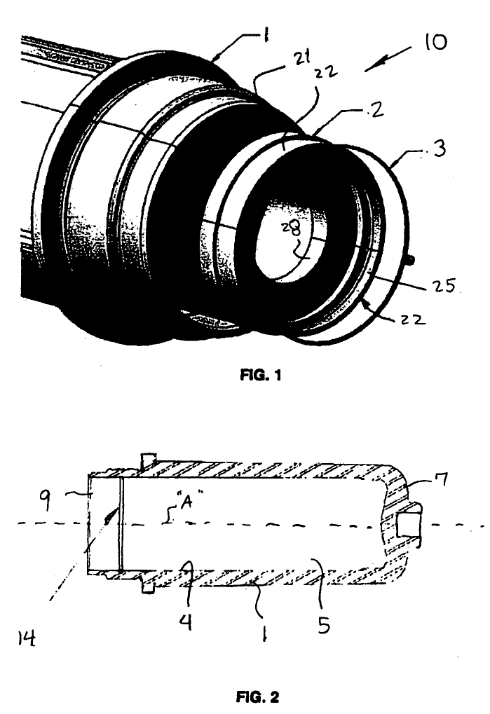

Referring now to FIG. 1, an embodiment of the disposable filter bowl assembly 10 is shown comprising a filter bowl 1, a filter element 2, and a retainer ring 3. As also shown in FIG. 2, the filter bowl 1 is generally in the form of a cup-shaped cylindrical housing having an interior wall surface 4 defining a generally cylindrical interior chamber 5 with a closed end 7 and an open end 9 to house the filter element 2 and the retainer ring 3. A manual or automatic drain (not shown) can be installed in the closed end of the filter bowl to allow impurities such as water to be periodically drained from the bowl during operation. The filter bowl 1 may be made in a one-piece, unitary structure of a lightweight, structural polymer material by an injection molding process. As an example, the polymer material may be a BASF Ultramid 30% glass-filled nylon material and DuPont Zytel 35% glass filled nylon material. The polymer filter bowl is recyclable and environmentally friendly as well as lightweight in comparison with most known metal filter canisters. The filter bowl may, of course, be made out of other material, as should be known to those skilled in the art.

A shallow groove or channel 14 is formed circumferentially around the surface of the interior chamber of the filter bowl 1 in a plane perpendicular or transverse to the central axis “A” of the cylindrical filter bowl 1, as best shown in FIG. 2. The groove is formed closer to the open end 9 of the filter bowl than the closed end, and is preferably formed proximate the open end 9. The location of the groove will be dictated primarily by the length of the element in the filter bowl, and the need for the filter bowl to extend outwardly from the filter to allow appropriate geometry (such as interior threads) to be used to attach the bowl to the filter head. The groove 14 is used as a locking groove for the retainer ring 3, and preferably extends continuously around the interior wall surface, although it is also possible that the groove could be discontinuous, and comprise a series of openings spaced in a circumferential manner about the interior wall surface.

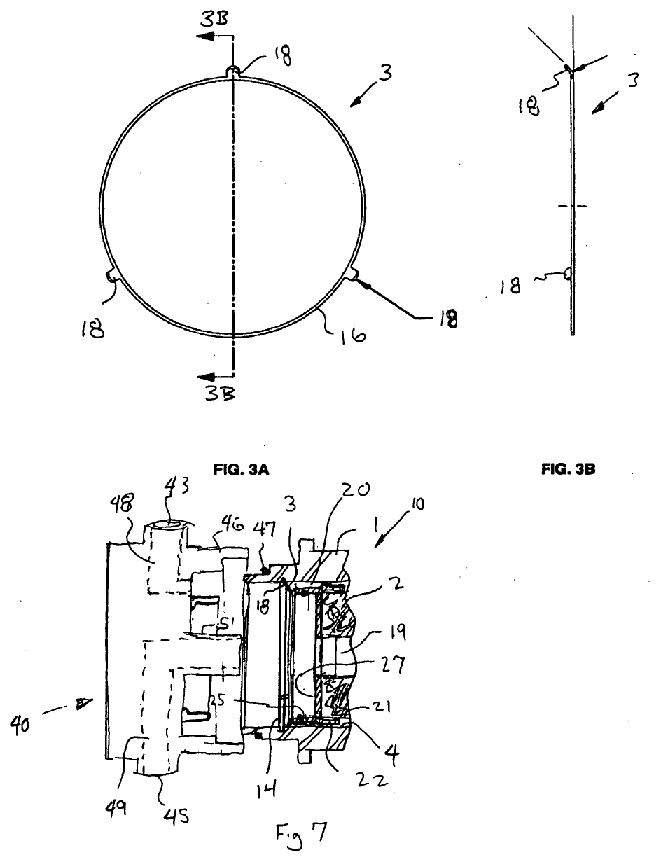

As best shown in FIGS. 3A and 3B, the retainer ring 3 has a flat annular frame 16 with a plurality of locking tabs 18 extending radially-outward therefrom. As best shown in FIG. 3B, the locking tabs are formed at an angle to the annular ring, that is, bent outwardly from the plane of the retainer ring, preferably in the same direction. The frame 16 of the ring has an outer diameter about the same size or just slightly less than the interior diameter of the filter bowl, such that the ring fits closely within the bowl; and the tabs are sized such that the tabs are easily and securely received in the groove 14 when the retainer ring is inserted through the open end of the filter bowl. The angled tabs have some flexibility to allow the ring to be pushed through the open end 9 of the bowl with the tabs bending somewhat in their angled direction; and then the tabs flex radially outward into the groove 14 as the ring is pushed past the groove. The ring can be assembled by hand into the filter bowl, or an appropriate tool can be used. The retainer ring 3 is positioned within the bowl such that the angled locking tabs extend from the annular ring toward the open end of the filter bowl 1. When assembled, the angled locking tabs securely engage the groove 14 in the filter bowl 1 and hold the filter 2 within the filter bowl 1. The retainer ring 3 is designed to be permanently installed in the filter bowl 1 as the tabs will prevent removal of the retainer ring 3.

Retainer ring 3 can be formed of a relatively rigid material appropriate for the particular application, such as a metal, or a high strength polymer. While three relatively thin, equally-spaced radially elongated tabs 18 are shown in the drawings, this is for illustration purposes only and it is possible that ring 3 could have more (or fewer) tabs, and that the tabs could be spaced in an even or uneven configuration around the ring. The radial and circumferential extent of the tabular portions and other dimensions of the ring could also vary depending upon the particular application, and while each tab is shown as being identical, the tabs could also be formed of different sizes and/or shapes. The ring could alternatively have a continuous, flexible radially-outward projecting portion, rather than having individual, separate tabular portions, which could also function to engage the groove when the ring is installed in the filter bowl. Still further, the ring could be discontinuous and likewise be compressed during installation and then expand into the groove to retain the ring in the groove. If the groove 14 is discontinuous, the geometry of the groove could for the most part match the geometry of the tabular portions of the ring for ease of positioning the ring within the filter bowl.

As indicated above, filter 2 is located in the interior chamber 5 of the filter bowl 1 and defines a central area 19 within the element, and a peripheral area 20 exterior of the element and between the element and the filter bowl, as shown in FIG. 7. Referring now to FIGS. 4-6, filter 1 preferably is formed having a ring of media 21 with end caps 22, 23 at either end of the media bonded or otherwise attached such as with adhesive or by other means in a known manner. Media 21 is of a structure appropriate for the application (such as pleated, depth media, etc.), and can be formed of appropriate material (such as cellulose, polyester, etc.).

End cap 22 has an annular configuration with an annular flange 25 projecting axially outward from the end of the filter 2. An annular groove is formed along the inside surface of flange 25 and supports a resilient sealing ring 26. Ring 26 seals against an annular flange depending from the inside surface of the filter head when the filter bowl is installed on the head, as will be explained below. Flange 25 has a diameter at its end surface at least partially overlapping the diameter of the ring 3 (as can be seen in FIG. 7), and preferably having a diameter (inner and outer) approximately the same as ring 3, such that when ring 3 is located in groove 14, the ring abuts the end surface of flange 25. End cap 22 also includes an annular flat body portion 27, circumscribing a central circular opening 28, and projecting radially inward from flange 25. Short inner and outer skirts 29, 30 depend axially away from and bound the inner and outer diameter of annular body portion 27. Skirts 29, 30 and body portion 27 define an annular cavity that receives the end of media ring 21. The media ring is secured to the inside surface of body portion 27 using appropriate potting compound or other type of adhesive.

The end cap 23 at the opposite end of the media ring preferably has a simple circular configuration enclosing the end of the filter, and likewise has a configuration which bounds and is sealed to the opposite end of the media ring.

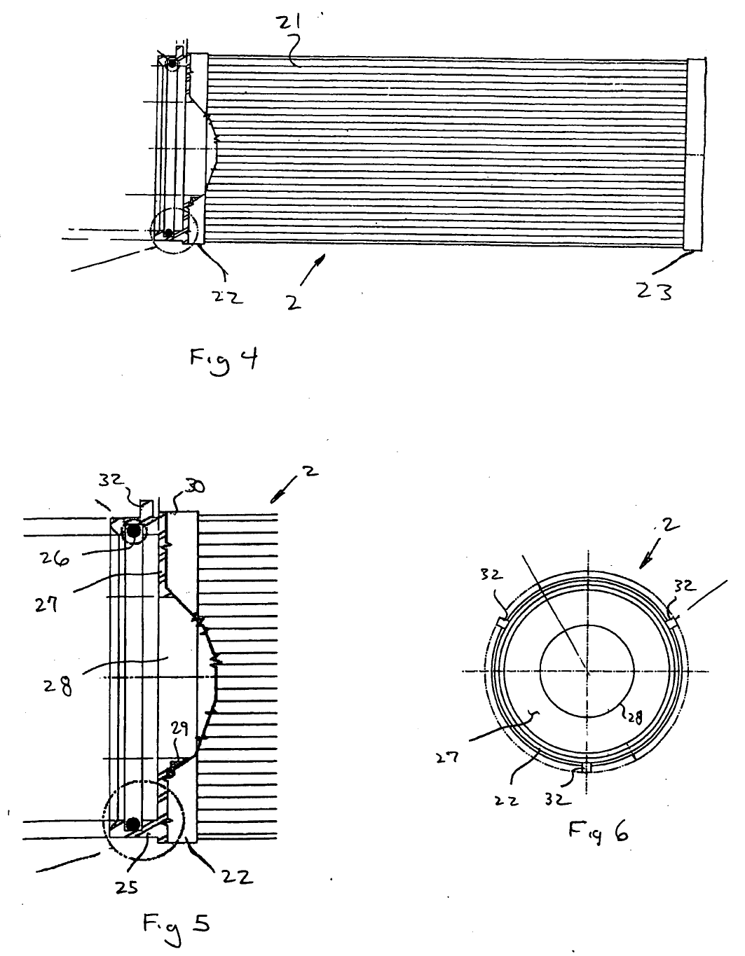

As can be seen in FIGS. 5 and 6, a series of short projections 32 are formed around end cap 22 and extend radially outward therefrom. Projections 32 have an outer dimension which fit closely within the interior wall surface 4 of filter bowl 1 (see FIG. 7). Projections 32 define the annular peripheral chamber 20 between filter 2 and bowl 1 to allow fluid flow therebetween, as will be described below.

The end caps 22, 23 for filter 2 are preferably also formed of material appropriate for the application, such as plastic or sheet metal, using appropriate techniques such as molding or forming. The end caps can be formed in multiple pieces and secured together; or as a single, unitary piece.

When the filter element 2 and retainer ring 3 are installed as described above, the filter element is securely held within the bowl. The filter bowl is then attached to a filter head, such as indicated generally at 40 in FIG. 4. Head 40 can be of a variety of configurations as is known in the art, and in most cases includes an inlet port 43 and an outlet port 45 with appropriate geometries enabling appropriate plumbing or fittings to be connected to fluidly connect the filter within a fluid system. An annular outer skirt or flange 46 projects outwardly from the underside of the head and is attached and sealed to the open end of the filter bowl. Appropriate resilient annular seals as at 47 can be provided between head 40 and bowl 1 to provide a fluid-tight seal. Appropriate internal passages 48, 49 connect inlet port and outlet port 45 with the underside of filter head 40—that is with the side of the head facing filter bowl 1. An annular flange or nipple 51 is provided in the underside of head 40 having a configuration which is closely received within the central opening 28 of the filter when the filter bowl is installed on the filter head and forming an outlet pathway for filtered fluid. An inner skirt or flange 55 projects outwardly from the underside of the filter head and is received within the annular flange 25 at the end of the filter element and sealed thereto via O-seal 26.

Passage 48 from inlet 43 generally opens radially outward of nipple 51 and directs fluid to be filtered into the filter bowl and into the peripheral area 20 between filter 2 and bowl 1. The seal between skirt 55 and end cap flange 25 separates the fluid to be filtered entering from passage 48, from the filtered fluid leaving the filter bowl via passage 49. The fluid then flows radially inward through the media, where particles and other contaminants are removed, and outwardly through the central opening 19 in the end cap 22 and through nipple 51 to the outlet passage 49 and outlet port 45 in filter head 40.

Bowl 1 can be connected to head 40 using any number of techniques, such as friction fit, or using screw threads on the interior or exterior of the end of the bowl, and on the interior/exterior of the head flange 46. Examples of such connections can be found in U.S. Pat. Nos. 6,959,819B2; 6,926,827B2 and 6,752,924B2; and International Publication WO 01/2677A1. Again, the filter bowl assembly of the present invention can be connected to a variety of filter heads or even directly to a fuel manifold or tank, and the above is only one example of such a connection using a filter head.

It should be apparent that the filter bowl assembly 10, including bowl 1, filter element 2 and retainer ring 3, can be easily assembled and connected to the filter head 40. During operation of the fluid system, fluid is directed through the filter media ring and contaminants are removed. When the element becomes spent, the filter bowl is removed from the filter head and a new filter bowl assembly is attached. If the filter bowl, ring and media are formed from appropriate material, they can be recycled or incinerated, as desired. The filter bowl assembly and filter head can be used to filter a variety of fluids, such as hydraulic fluids in a hydraulic fluid system; or fuel in a fuel system.

As the filter bowl assembly 10 cannot be disassembled (or at least easily disassembled), the disposable filter bowl assembly 10 is simply removed and discarded while a new disposable filter bowl assembly 10 is installed, thus addressing many of not all of the issues associated with the prior art.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. Accordingly, the scope and content of the present invention are to be defined only by the terms of the appended claims.

What is claimed is:

1. A filter bowl assembly comprising:
a filter bowl;
a filter located in the filter bowl; and
a non-removable retainer ring engaging the filter bowl in a manner securing the filter within the filter bowl.

2. The filter bowl assembly as in claim 1, wherein the filter bowl includes an inner wall surface, and geometry is provided along the interior wall surface which is engaged by the retainer ring.

3. The filter bowl assembly as in claim 2, wherein the geometry comprises a groove.

4. The filter bowl assembly as in claim 1, wherein the filter bowl comprises a cup-shaped cylindrical housing having an interior wall surface defining a cylindrical interior chamber, a closed end and an open end, and the geometry comprises a groove in the interior wall surface.

5. The filter bowl assembly as in claim 4, wherein the groove is continuous, and extends circumferentially around the interior wall surface of the filter bowl, in a plane transversely to a central axis of the filter bowl.

6. The filter bowl assembly as in claim 5, wherein the groove is closer to the open end than the closed end of the filter bowl.

7. The filter bowl assembly as in claim 6, wherein the groove is proximate the open end of the filter bowl.

8. The filter bowl assembly as in claim 1, wherein the retainer ring is continuous.

9. The filter bowl assembly as in claim 8, wherein the retainer ring comprises an annular frame, and flexible geometry projecting radially outward from the frame.

10. The filter bowl assembly as in claim 9, wherein the geometry comprises a series of distinct tabs, projecting radially outward, at an angle to the plane of the ring.

11. The filter bowl assembly as in claim 1, wherein the tabs are spaced evenly around the circumference of the ring.

12. The filter bowl assembly as in claim 1, wherein the filter includes an end cap, and the retainer ring abuts the end cap.

13. The filter bowl as in claim 12, wherein the end cap includes an annular body portion sealingly bonded to the media ring, and an annular flange projecting axially outward away from the body portion, the annular flange having a dimension about the same as the dimension of the retaining ring such that the retaining ring abuts an end of the annular flange.

14. A method for securing a filter in a disposable filter bowl, the method comprising the steps of:
providing a generally cylindrical filter bowl having an interior wall surface defining a generally cylindrical interior chamber;
forming a groove in the surface of the interior chamber in a plane perpendicular to the axis of the cylindrical filter bowl;
providing a retainer ring having an annular portion and a plurality of engaging portions extending radially outward from the annular portion;
inserting the filter into the interior chamber of the filter bowl;
subsequently inserting the retainer ring into the interior chamber of the filter bowl wherein the annular portion of the retainer ring engages the filter and the plurality of engaging portions of the retainer ring engage the groove in the filter bowl in a manner securing the filter within the filter bowl.

15. A disposable filter bowl assembly comprising:
a generally cylindrical cup-shaped filter bowl having an interior wall surface defining a generally cylindrical interior chamber;
a groove formed in the surface of the interior chamber circumferentially around the chamber, the groove extending in a plane perpendicular to the central axis of the cylindrical filter bowl;
a filter located in the interior chamber of the filter bowl; and
a retainer ring having an annular filter engaging portion and a plurality of filter bowl engaging portions extending radially outward from the filter engaging portion, the filter bowl engaging portions positioned within the groove of the filter bowl securing the filter within the filter bowl.
